(19) United States
(12) Patent Application Publication
(10) Pub. No.: US 2007/0010633 A1
(43) Pub. Date: Jan. 11, 2007

(54) Toughened polyoxymethylene resin composition

(76) Inventors: Yong-Soen Park, Gyeongsangbuk- do (JP); Moon-Cheul Shin, Daegu (KR); Mok-Geun Lim, Gyeongsangbuk-do (KR)

Correspondence Address: JORDAN AND HAMBURG LLP, 122 EAST 42ND STREET, SUITE 4000, NEW YORK, NY, 10168, US

(21) Appl. No.: 10/541,126

(22) PCT Filed: Dec. 30, 2003
(86) PCT No.: PCT/KR03/02911

§ 371 Date: Sep. 20, 2006

(30) Foreign Application Priority Data
Dec. 31, 2002 (KR) 1020020088060

(51) Int. Cl. C08L 61/02; C08G 67/00

(52) U.S. Cl. 525/445; 525/472

(57) ABSTRACT

Disclosed is a toughened polyoxymethylene resin composition, including a polyoxymethylene resin, a polyether-ester block copolymer derived from copolymerization of a hard segment including a dicarboxylic acid component and a glycol component and a soft segment including a poly(tetramethylene oxide)terephthalate unit, and a modified polyethylene polymer, which is advantageous in terms of high mechanical properties with an Izod notch impact strength of 10 kg-cm/cm or more and a tensile strength of 550 kg/cm² or more, while maintaining a dot impact strength of 5 J or more. Hence, molded articles using the above resin composition are improved in resistance to impact, wear and friction, and thus, can be usefully applied to gears or bearings having low noise.

### TECHNICAL FIELD

The present invention relates to polyoxymethylene resin compositions, and more specifically, to a toughened polyoxymethylene resin composition having excellent mechanical strength.

### BACKGROUND ART

Generally, polyoxymethylene (hereinafter, abbreviated as ‘POM’), which is a resin exhibiting excellent balance of mechanical properties and physical properties, has superior mechanical properties and chemical properties, such as chemical resistance and heat resistance, and thus, has been widely used as a representative engineering resin. However, the POM resin has a higher crystallinity, compared to other resins, and exhibits rigid characteristics, making it very brittle. Therefore, with the intention of improving the brittle properties of the POM resin, research for the addition of a toughness enhancer or the enhancement of compatibility between the POM without a reactive group and the toughness enhancer has been vigorously undertaken. In the cases where the POM resin having a higher wear resistance compared to other resins is increased in flexibility, it suffers from lowered mechanical properties. Hence, there are required methods for solving the above problems.

The preparation of the toughened POM is exemplified by a method of adding a hydrocarbon rubber having a nitrile group or a carboxylic acid ester group to a side chain of the POM (Japanese Patent No. Sho. 45-12674), a mixing method of α-olefin/α,β-unsaturated carboxylic acid copolymer (Japanese Patent No. Sho. 45-18023), and a mixing method of ethylene/vinyl or acryl ester copolymer (Japanese Patent No. Sho. 45-2623 1). In addition, there are disclosed methods of increasing impact strength and bending elastic modulus by adding a nitrile group-substituted copolymer to a hydrocarbon main chain of diolefin/acrylonitrile copolymer (PN 3,476,832), mixing of aliphatic polyether (Japanese Patent No. Sho. 50-33095), mixing of α-olefin polymer and copolymer of ethylene/vinyl monomer (Japanese Patent Laid-open Publication No. Sho. 49-40346), and mixing of a thermoplastic elastomer, such as polyolefin, polystyrene, polyester, and polyamide (Japanese Patent Laid-open Publication No. Sho. 60-104116). However, the above methods are disadvantageous in terms of low compatibility with the POM, and thus, cannot drastically increase impact strength.

To provide higher toughness, Canadian Patent No. 84-2325 proposes a method of using a thermoplastic polyurethane as an elastomer, and also Japanese Patent Laid-open Publication No. Sho. 59-155453 discloses a method of controlling the dispersion state of polyurethane. Moreover, in Japanese Patent Laid-open Publication No. Sho. 59-145243, there is disclosed the preparation of a specific elastomer polyurethane to increase compatibility with the POM. However, upon the mixing of the polyurethane with the POM, impact strength increases in proportion to the amount of polyurethane used, whereas moldability and rigidity decrease. Hence, it is difficult to practically apply the POM resin.

### DISCLOSURE OF THE INVENTION

Leading to the present invention, the intensive and thorough research on polyoxymethylene resin compositions suitable for use in mechanical tools, carried out by the present inventors aiming to avoid the problems encountered in the related art, resulted in the finding that a polyoxymethylene resin is mixed with a polyethylene modified polymer component, whereby adhesion between the polyoxymethylene resin and a polyester copolymer increases, and also, flexibility and resistance to friction and wear are improved while maintaining mechanical properties, in particular, rigidity, of the polyoxymethylene resin upon a molding process, thus obtaining a toughened polyoxymethylene resin composition with desired mechanical properties, such as an Izod notch impact strength of 10 kg·cm/cm or higher, and a tensile strength of 550 kg/cm² or higher, in addition to balanced rigidity and toughness.

Therefore, it is an object of the present invention to provide a novel polyoxymethylene resin composition suitable for use in mechanical tools.

To achieve the above object of the present invention, there is provided a toughened polyoxymethylene resin composition, comprising (a) 100 parts by weight of a polyoxymethylene resin, (b) 5-60 parts by weight of a polyether-ester block copolymer derived from the copolymerization of a hard segment including a dicarboxylic acid component and a glycol component and a soft segment including a poly(tetramethylene oxide)terephthalate unit, and (c) 0.1-10 parts by weight of a modified polyethylene polymer, with a dot impact strength of 5 J or more, an Izod notch impact strength of 10 kg·cm/cm or more, and a tensile strength of 550 kg/cm2 or more, wherein the resin has a dispersion phase amounting to 2 to 5 μm when a molded article of the composition is broken at low temperatures.

### BEST MODE FOR CARRYING OUT THE INVENTION

As for a polyoxymethylene resin composition provided by the present invention, a polyoxymethylene resin used as a main component is preferably an oxymethylene homopolymer or an oxymethylene copolymer containing 85 parts by weight or more of an oxymethylene unit as a main chain and 15 parts by weight or less of an oxyalkylene unit having 2 to 8 carbon atoms. The preparation methods of the oxymethylene homopolymer and the oxymethylene copolymer are known in the art. For example, the oxymethylene homopolymer is typically prepared by polymerizing anhydrous formaldehyde in an organic solvent having a basic polymerization catalyst, such as organic amine, to obtain a polymer, which is then stabilized (e.g., acetylation by acetic anhydride). In addition, the oxymethylene copolymer is prepared by directly polymerizing anhydrous trioxane and ethylene oxide or 1,3-dioxolene as a copolymerizable component, or polymerizing trioxane in a cyclohexane or benzene solvent in the presence of a Lewis acid catalyst, followed by the decomposition and then removal of an unstable terminal by use of a basic compound.

Further, used for the inventive polyoxymethylene resin composition, a polyether-ester block copolymer comprises a polyether-ester block copolymer derived from the copolymerization of a hard segment, which contains a dicarboxylic acid component and a glycol component, and a soft segment of poly(tetramethylene oxide)terephthalate unit. Preferably, use is made of a segmented block copolymer including the hard segment having the dicarboxylic acid component formed of the butylene terephthalate unit and the glycol component and the soft segment formed mainly of the poly(tetramethylene oxide)terephthalate unit.

The dicarboxylic acid component in the hard segment comprises terephthalic acid alone, or a mixture of 70 mol % or more of terephthalic acid and 30 mol % or less of aromatic dicarboxylic acid, such as isophthalic acid, phthalic acid, naphthalene-2,6-dicarboxylic acid, diphenyl-4,4′-dicarboxylic acid and 3-sulfone isophthalic acid, and/or alicyclic dicarboxylic acid, such as oxalic acid, succinic acid, adipic acid, azellic acid, sebacic acid, dodecanoic acid and dimer acid. Among the copolymerizable components, it is preferable to use isophthalic acid, adipic acid, sebacic acid and dodecanoic acid.

Also, the glycol component in the hard segment comprises 1,4-butanediol alone, or a mixture of 50 wt % or more of 1,4-butanediol and 50 wt % or less of a copolymerizable component selected from the group consisting of ethyleneglycol, diethyleneglycol, propyleneglycol, 1,6-hexanediol, 1,10-decanediol, 1,4-dihydroxymethyl cyclohexane, bis(4-hydroxyethoxyphenyl)methane, neopentylglycol, and mixtures thereof.

The dicarboxylic acid component in the soft segment consists mainly of terephthalic acid. As in the dicarboxylic acid component of the hard segment, the dicarboxylic acid component of the soft segment comprises terephthalic acid alone, or 70 wt % or more of terephthalic acid and 30 wt % or less of dicarboxylic acid as a copolymerizable component, in which the copolymerizable component of the soft segment is defined as in the hard segment above.

Poly(tetramethylene oxide)glycol, which constitutes the poly(tetramethylene oxide)terephthalate unit of the soft segment, has a number average molecular weight of 500 to 20,000, and preferably, 5,000 to 15,000. In particular, poly(tetramethylene oxide)glycol having a number average molecular weight of 8,000-10,000 is preferable, in consideration of the compatibility with the POM resin. If the number average molecular weight of the poly(tetramethylene oxide)glycol is smaller than 500, impact resistance is drastically decreased. Meanwhile, if the number average molecular weight is larger than 20,000, the compatibility with the butyl terephthalate unit of the hard segment becomes poor, and thus, uniform polyether-ester block copolymer cannot be prepared.

As for the polyether-ester block copolymer comprising the hard segment composed mainly of the butylene terephthalate unit and the soft segment composed mainly of the poly(tetramethylene oxide)carboxylate unit, the poly(tetramethylene oxide)carboxylate unit constitutes 30 to 80 wt %, and preferably, 50 to 75 wt % in the polyether-ester block copolymer. When the amount of the poly(tetramethylene oxide)carboxylate unit is larger than 80 wt %, it is difficult to polymerize the polyether-ester block copolymer, and also, the mechanical strength of the composition decreases.

The preparation method of the polyether-ester block copolymer is well-known in the art. For example, the polyether-ester block copolymer is obtained by introducing terephthalic acid (or dimethyl terephthalate), 1,4-butanediol and poly(tetramethylene oxide)glycol into a reactor equipped with a rectification column, followed by esterification (or transesterification) under atmospheric pressure or increased pressure, and then polymerization under atmospheric pressure or reduced pressure. Alternatively, terephthalic acid (or dimethyl terephthalate), 1,4-butanediol and poly(tetramethylene oxide)glycol are added to an oligomer, and then polymerized under atmospheric pressure or reduced pressure.

In the present invention, the polyether-ester block copolymer is used in the amount of 5-60 parts by weight, and preferably, 10-40 parts by weight, based on 100 parts by weight of the POM resin. Use of the polyether-ester block copolymer smaller than 5 parts by weight results in low flexibility, whereas use of the polyether-ester block copolymer larger than 60 parts by weight results in drastically decreased mechanical strength.

Moreover, the polyoxymethylene resin composition of the present invention further includes a modified polyethylene polymer as a compatibilizer. The modified polyethylene polymer is exemplified by Fusabond MN-493D of Du-Dow Co. Ltd., which is an ethylene-octene copolymer having 0.4 wt % of grafted maleic anhydride. The modified polyethylene polymer is used in the amount of 0.1-10 parts by weight, and preferably, 0.3-5.0 parts by weight, based on 100 parts by weight of the POM resin. When the amount of the modified polyethylene polymer is smaller than 0.1 parts by weight, compatibility of the POM resin with the polyether-ester block copolymer decreases. On the other hand, when the amount exceeds 10 parts by weight, rigidity decreases and economic benefits do not occur.

In addition, the present resin composition has a known additive so long as the use of the additive does not harm the purposes of the present invention. Such an additive is exemplified by hindered phenol-, phosphite-, thioether- or amine-based antioxidants; benzophenone- or hindered amine-based weather-resistant stabilizers; removing agents of formaldehyde, such as melamine, dicyanediamide, polyamide or polyvinylalcohol copolymer; releasing agents, such as fluorine-containing polymer, silicone oil, metal salts of stearyl acid, metal salts of montanic acid, montanic acid ester wax or polyethylene wax; coloring agents (dyes or pigments); ultraviolet blocking agents, such as titanium oxide or carbon black; reinforcing agents, such as glass fiber, carbon fiber or potassium titanate fiber; fillers, such as silica, clay, calcium carbonate, calcium sulfate or glass bead; nucleating agents, such as talc or clay; plasticizers; adhesive aids; and adhesives.

Having generally described this invention, a further understanding can be obtained by reference to specific examples and comparative examples which are provided herein for purposes of illustration only and are not intended to be limiting unless otherwise specified.

The properties mentioned as below were measured according to the following procedures:
Relative Viscosity (ηr): A 0.5% polymer in o-chlorophenol was measured at 25° C.
Mechanical Properties: An ASTM dumbbell-type test piece and an Izod impact test piece were molded under the conditions of a cylinder temperature of 190° C., a mold temperature of 80° C. and a molding cycle of 40 sec, by use of an injection molding machine having a 60 ton injection capability. The tension test piece was measured for tensile strength according to ASTM D638, and the Izod impact test piece was measured for impact strength according to ASTM D256.
Dot Impact Strength: A disk having a thickness of 2 mm and a diameter of 10 cm was molded under the conditions of a cylinder temperature of 190° C., a mold temperature of 80° C. and a molding cycle of 40 sec, by use of an injection molding machine having a 60 ton injection capability. Then, measurement was performed at room temperature by controlling, at 2.2 m/sec, the falling rate of a ball with a diameter of 0.5 inch and a weight of 3.18 kg falling to the disk by use of a falling ball impact device. As such, the measured data was impact energy absorbed to the disk.
Size of Dispersion Phase: A size of polyether-ester, as a dispersion phase, dispersed in the polyoxymethylene resin were evaluated by breaking the impact test piece molded to determine the mechanical properties at −40° C. and then observing the section of the test piece by means of an electron microscope.

A preparation method of the polyether-ester block copolymer and a composition thereof are as follows:

### PREPARATION EXAMPLE 1

### Polyether-ester Block Copolymer

1000 g of dimethyl terephthalate, 1085 g of poly(tetramethylene oxide)glycol having a number average molecular weight of 8000, 823 g of 1,4-butanediol and 0.005% titan tetrabutoxide as a catalyst were placed into a reactor equipped with spiral and ribbon type stirring wings. The reaction mixture was heated at 190-225° C. for 3 hours for transesterification. Then, the temperature increased to 245° C. and pressure in the system reduced to 1 mmHg for 50 min, after which the polymerization was performed for 2.5 hours. Thusly obtained polymer was extruded in a strand form in water, and cut, to obtain a pellet, which was referred to as A-2. Thereafter, the polymerization was performed using the components shown in the following Table 1 according to the above procedure, and thus, A-1, A-3 and A-4 were prepared. The relative viscosity (ηr) of each of the prepared polymers is given in Table 1, below.

Components of A-2

The reactants, represented by weight unit when being placed into the reactor, reacted according to each mol equivalent upon the polymerization, and thus, the weight unit was converted to a mol equivalent. That is,
dimethyl terephthalic acid: 1000 g=5.1497 mol
poly(tetramethylene oxide)glycol (m.w. 8000): 1085 g=0.1356 mol
1,4-butanediol: 823 g=9.132 mol

As such, 1,4-butanediol, excessively added to the reaction, did not have to be accurately used because the remaining amount thereof was discharged out of the system during the polymerization under vacuum conditions. Hence, after the polymerization, the amount applied to the polymerization was calculated from dimethyl terephthalic acid.

1. Poly(tetramethylene oxide)terephthalate (parts by weight)

repeating unit m.w.: 8133.107 g=(DMT m.w.+glycol m.w.)−2(methanol m.w.)

partial weight of the polymer=8133.107×0.1356=1102.85

2. Butylene Terephthalate (parts by weight)

Since 1,4-butanediol was excessively added, the above amount was calculated on the basis of terephthalic acid.

mol number of dimethylterephthalic acid=added mol number−reaction mol number of the polymer=5.1497−0.1356=5.0141

repeating unit m.w.: 220.227=(DMT+BD)−2×methanol

partial weight of the polymer=220.227×5.0141=1104.24

Thus, butylene terephthalate (parts by weight): poly(tetramethylene oxide)terephthalate (parts by weight)=50:50 (A-2)

TABLE 1

| | Butylene | Poly(tetramethyleneoxide) | Relative |
|---|---|---|---|
| | Terephthalate Unit | Terephthalate Unit | Viscosity |
| | (Parts by Weight) | (Parts by Weight) | (ηr) |
| A-1 | 70 | 30 | 1.71 |
| A-2 | 50 | 50 | 2.10 |
| A-3 | 20 | 80 | 2.92 |
| A-4 | 10 | 90 | 2.95 |

### PREPARATION EXAMPLE 2

### Polyether-ester Block Copolymer

1000 g of dimethyl terephthalate, 1499 g of poly(tetramethylene oxide)glycol having a number average molecular weight of 500, and 465.6 g of 1,4-butanediol were placed into a reactor equipped with spiral and ribbon type stirring wings, after which the polymerization was performed in the same manner as in Preparative Example 1. Thusly obtained polymer was referred to as B-i. Then, B-2, B-3 and B-4 were prepared according to the above procedure, using the poly(tetramethylene oxide)glycol having a molecular weight of 3000, 15000 and 25000. The composition ratio of the hard segment/soft segment in the B-1 to B-4 was 20/80 parts by weight. The relative viscosity of the polymers is given in Table 2, below.

TABLE 2

| | Soft Segment Component-m.w. | Relative Viscosity (μr) |
|---|---|---|
| B-1 | Poly(tetramethyleneoxide)glycol-500 | 1.28 |
| B-2 | Poly(tetramethyleneoxide)glycol-3000 | 2.63 |
| B-3 | Poly(tetramethyleneoxide)glycol-15000 | 3.94 |
| B-4 | Poly(tetramethyleneoxide)glycol-25000 | 5.10 |

### Examples 1 to 4 and Comparative Examples 1 to 7

A cylinder temperature was set to 190° C. using a twin screw type heating kneader, after which 100 parts by weight of a polyoxymethylene resin dried at 80° C. for 4 hours under vacuum conditions was mixed with a modified polyethylene polymer as a compatibilizer, and then introduced into a first inlet of a twin screw extruder while the polyether-ester copolymer was added in a corresponding amount (parts by weight). The above mixture was sufficiently melted and kneaded at 190° C. using the twin screw extruder, discharged in a long and narrow tube shape through a die, cooled, and then cut by use of a pelletizer, to obtain a polyoxymethylene resin composition as a chip. The resin composition was sufficiently dried, and a test piece for measurement of various physical properties was injection molded at 190° C. and measured for the properties. The results are shown in Table 3, below.

TABLE 3

| | | | | Izod Impact | | | |
|---|---|---|---|---|---|---|---|
| | | Polyether-ester | Modified | Strength | Tensile | Dot Impact | Dispersion |
| | | Copolymer | Polyethylene | (Kg · cm/ | Strength | Strength | Size |
| | No. | (wt part) | (wt part) | cm) | (Kg/cm²) | (J) | (μm) |
| Ex. | 1 | A-2 (10) | 2 | 15 | 597 | 11.2 | 2-3 |
| | 2 | A-3 (40) | 2 | 21 | 553 | 13.7 | 3-4 |
| | 3 | B-2 (8) | 2 | 13 | 618 | 7.8 | 2-3 |
| | 4 | B-1 (15) | 1 | 14 | 567 | 12.8 | 4-5 |
| C. Ex. | 1 | 0 | 2 | 5.4 | 680 | 0.9 | — |
| | 2 | A-2 (15) | 0 | 6.5 | 482 | 1.3 | 20-50 |
| | 3 | B-2 (2) | 1 | 7.4 | 617 | 1.2 | 3-5 |
| | 4 | A-3 (65) | 3 | 13 | 418 | 12.3 | 5-10 |
| | 5 | A-1 (30) | 3 | 11 | 495 | 3.1 | 5-10 |
| | 6 | A-4 (10) | 1 | 7.9 | 584 | 2.7 | 10-15 |
| | 7 | B-4 (15) | 2 | 10 | 553 | 3.8 | 10-15 |

*POM resin: Kocetal K300 of KTP Co. LTD., Korea, as a medium viscosity resin (melt index 9 g/10 min)
*Modified Polyethylene Polymer: Fusabond MN-493D (Du-Dow Co. Ltd.)

### INDUSTRIAL APPLICABILITY

As described hereinbefore, the present invention provides a toughened polyoxymethylene resin composition having superior mechanical properties of an Izod notch impact strength of 10 kg·cm/cm or more, and a tensile strength of 550 kg/cm² or more, while maintaining a dot impact strength of 5 J or more. Thus, molded articles using the above resin composition are improved in resistance to impact, wear and friction. Further, polyether-ester used as a toughness enhancer in the resin has a dispersion size of 2-5 μm, thus exhibiting balanced characteristics of rigidity and flexibility. Therefore, the above resin composition can be applied to gears or bearings having low noise.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A toughened polyoxymethylene resin composition, comprising (a) 100 parts by weight of a polyoxymethylene resin, (b) 5-60 parts by weight of a polyether-ester block copolymer derived from copolymerization of a hard segment including a dicarboxylic acid component and a glycol component and a soft segment including a poly (tetramethylene oxide) terephthalate unit, and (c) 0.1-10 parts by weight of a modified polyethylene polymer, with a dot impact strength not less than 5 J, an Izod notch patch impact strength not less than 10 kg·cm/cm, and a tensile strength not less than 550 kg/cm², wherein the resin has a dispersion phase amounting to 2 to 5 μm when a molded article of the composition is broken at low temperatures.

2. The composition as defined in claim 1, wherein the dicarboxylic acid component comprises terephthalic acid alone, or a mixture of terephthalic acid and any one of aromatic dicarboxylic acid and alicyclic dicarboxylic acid.

3. The composition as defined in claim 1, wherein the dicarboxylic acid component comprises a mixture of 70 wt % or more of terephthalic acid and 30 wt % or less of any one selected from the group consisting of aromatic dicarboxylic acid, alicyclic dicarboxylic acid, and mixtures thereof.

4. The composition as defined in claim 2 or 3, wherein the aromatic dicarboxylic acid is selected from the group consisting of isophthalic acid, phthalic acid, naphthalene-2,6-dicarboxylic acid, diphenyl-4,4′-dicarboxylic acid, 3-sulfoneisophthalic acid, and mixtures thereof.

5. The composition as defined in claim 2 or 3, wherein the alicyclic dicarboxylic acid is selected from the group consisting of oxalic acid, succinic acid, adipic acid, azellic acid, sebacic acid, dodecanoic acid, dimer acid, and mixtures thereof.

6. The composition as defined in claim 1, wherein the glycol component comprises 1,4-butanediol alone, or 50 wt % or more of 1,4-butanediol and 50 wt % or less of a copolymerizable component selected from the group consisting of ethyleneglycol, diethyleneglycol, propyleneglycol, 1,6-hexanediol, 1,10-decanediol, 1,4-dihydroxymethyl cyclohexane, bis(4-hydroxyethoxyphenyl) methane, neopentylglycol, and mixtures thereof.

7. The composition as defined in claim 1, wherein the soft segment comprises poly (tetramethylene oxide) glycol constituting the poly (tetramethylene oxide) terephthalate unit.

8. The composition as defined in claim 7, wherein the poly (tetramethylene oxide) glycol has a number average molecular weight of 500-20,000.

9. The composition as defined in claim 1, wherein the poly(tetramethylene oxide) carboxylate unit is used in an amount of 30 to 80 wt %.
